(19) United States
(12) Patent Application Publication
(10) Pub. No.: US 2024/0277566 A1
(43) Pub. Date: Aug. 22, 2024

(54) CPR ASSISTANCE SYSTEMS

(71) Applicant: Stryker Corporation, Kalamazoo, MI (US)

(72) Inventor: Dennis Changmin Sohn, Seattle, WA (US)

(73) Assignee: Stryker Corporation, Kalamazoo, MI (US)

(21) Appl. No.: 18/443,274

(22) Filed: Feb. 15, 2024

Related U.S. Application Data
(60) Provisional application No. 63/446,778, filed on Feb. 17, 2023.

(51) Int. Cl. A61H 31/00

(52) U.S. Cl. CPC A61H 31/005; A61H 31/007; A61H 2201/0153; A61H 2201/1253; A61H 2201/1619; A61H 2201/1645; A61H 2201/5043; A61H 2201/5061; A61H 2201/5097; A61H 2203/0443; A61H 2205/084; A61H 2230/065; A61H 2230/201; A61H 2230/255; A61H 2230/305

(57) ABSTRACT

Systems and methods described herein relate to cardiopulmonary resuscitation (CPR) devices and systems for securing the same to hands of users. The systems and methods herein provide for a CPR assistance device, such as a CPR puck, to be releasably coupled with the hand of a user using a securing device that may be releasably coupleable to the hand of the user and/or the CPR puck. The CPR puck includes a sensor to detect a compression of the body between the chest of the subject and the hand of the user. The systems enable low-cost solutions to increase the effectiveness of CPR pucks during use and ease of use by rescuers.

### CROSS-REFERENCE TO RELATED APPLICATION

This application claims priority to U.S. Provisional App. No. 63/446,778, which was titled “CPR Assistance Systems,” filed on Feb. 17, 2023, and is incorporated by reference herein in its entirety.

### BACKGROUND

Many techniques exist for resuscitating a patient suffering from a life-threatening condition. Patient conditions that may require resuscitation include, but are not limited to, cardiac arrest, bradycardia, tachycardia, ventricular fibrillation, and respiratory arrest. One example of a technique for resuscitating a patient is performing Cardiopulmonary Resuscitation (CPR).

CPR is a technique used by a rescuer in an emergency situation to transport oxygen in patient's blood to the patient's vital organs and extremities. CPR can prevent cell death due to hypoxia when the patient's heart has stopped beating or the patient is not breathing spontaneously. When performing CPR, the rescuer creates blood circulation in the patient's body by periodically compressing the patient's chest.

Chest compressions produce blood circulation as the result of a generalized increase in intrathoracic pressure and/or direct compression of the heart. A patient can be kept alive using CPR provided the rescuer(s) are able to continue delivering properly performed chest compressions and rescue breaths. CPR assistance devices, such as a CPR puck, can be used to aid a rescuer in providing feedback about the manner and technique of the CPR administered to the patient. Such CPR pucks may be positioned between the hands of the rescuer and the patient during administration of CPR.

### DESCRIPTION OF THE DRAWINGS

FIG. 1 illustrates an example of a method of resuscitating a patient wherein a user uses CPR puck to resuscitate a patient, according to at least one example.

FIG. 2 illustrates an example of a side view of a user using a CPR puck to resuscitate a patient, according to at least one example.

FIGS. 3A-3B illustrate a CPR puck securable to a hand of a user through an adjustable strap, according to at least one example.

FIGS. 4A-4B illustrate a CPR puck securable to a hand of a user through a double-sided adhesive, according to at least one example.

FIGS. 5A-5C illustrate a CPR puck securable to a hand of a user through an accordion-style grip, according to at least one example.

FIGS. 6A-6B illustrate a CPR puck securable to a hand of a user through a hook and loop fastener, according to at least one example.

FIGS. 7A-7B illustrate a CPR puck securable to a hand of a user through a magnetic attachment, according to at least one example.

FIGS. 8A-8C illustrate a CPR puck securable to a hand of a user through a keyhole attachment, according to at least one example.

FIG. 9 illustrates a CPR puck securable to a hand of a user including a brace for maintaining a wrist position of the user, according to at least one example.

FIG. 10 illustrates a CPR puck having a sleeve for securing to a hand of a user, according to at least one example.

### DETAILED DESCRIPTION

Various implementations described herein relate to a methods and systems for securing a CPR puck in position relative to a hand of a user. In some implementations, the CPR puck is sized and shaped to be disposed upon a chest region of a patient. The term “puck” is used herein for purposes of illustration, not for purposes of limitation. The term “puck” as used herein is intended to encompass any object sized and shaped with at least one surface to be placed upon the chest region of a patient in need of resuscitation where the dimensions surface area are generally greater than an average depth of the object. A CPR “puck” as used herein, refers to a CPR assist device, CPR chest compression sensor, or CPR coaching device and may alternatively be referred to by such terms at times throughout this disclosure.

In some implementations, a CPR puck may be composed of a soft compressible material. In some implementations, the CPR puck may be composed of a hard material. In various implementations, the CPR puck may be composed of any material capable of being sized and shaped to be disposed upon a chest region of a patient.

Typical CPR pucks are utilized when users grip and hold the device while performing CPR. It may be difficult to bend the wrist backwards and achieve the correct wrist angle and position to deliver CPR with the proper technique using the palm of the hand while gripping the CPR puck with fingertips. Additionally, gripping the CPR puck requires extra energy. If the user has sweaty hands, the CPR puck may slide with respect to the hands during use. These and other problems may result in incorrect positioning of the hand(s) and/or CPR puck relative to the patient. In addition, these and other problems prevent the user from administering chest compressions at an appropriate depth, frequency, and timing. Incorrect chest compression position, depth, frequency, or timing can prevent the chest compressions from effectively transporting blood to the extremities, brain, and other vital organs of the patient, which can result in permanent harm to the patient.

The description provided herein provides for various securing mechanisms to couple the hand of the user to the CPR puck so the user does not have to grip the CPR puck, especially during an upward motion of chest compressions. Additionally, the user may be able to relax their fingers and deliver CPR using their palm more effectively. Furthermore, when the hand of the user gets sweaty or slippery, the CPR puck is maintained in position without additional effort expended by the user.

Various implementations described herein are directed to specific improvements in the technical field of emergency medical devices. For instance, by providing methods and systems to secure the CPR pucks to the hands of the users, the users may provide more effective chest compressions and expend less energy while performing CPR. Additionally, the systems and methods described herein enable the devices to be reusable, sanitizable, and/or disposable for use in emergency medical situations while still enabling the benefits described herein.

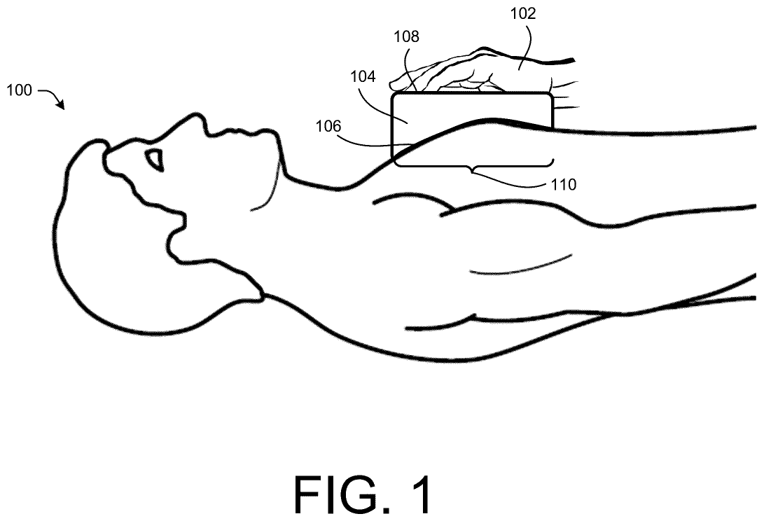

FIG. 1 illustrates a method of resuscitating a patient wherein a user uses a CPR puck 104 to resuscitate a patient 100, according to at least one example. The user may determine an orientation for the CPR puck 104 and place the CPR puck 104 in position before administering compressions. The user may secure the CPR puck 104 to their hand 102 using one or more of the securing devices described herein such that the CPR puck 104 remains in contact with the hand 102 of the user.

The CPR puck 104 includes a body that has a first surface 106 that contacts the chest region 110 of the patient 100. The CPR puck 104 further includes a second surface 108 that includes one or more of the securing devices described herein for releasably coupling the CPR puck 104 to the hand 102 of the user. Thus, the CPR puck 104 is configured to remain in position with respect to the patient 100 without the user having to grasp the CPR puck 104.

The user determines an orientation of the CPR puck 104, which may include identifying the first surface 106 and the second surface 108, and securing the CPR puck 104 to their hand 102. The user then places the CPR puck 104 in contact with the chest region 110, and with their hand 102 secured to the CPR puck 104, administers chest compressions to the patient 100.

During the chest compressions, the CPR puck 104 is configured to detect one or more chest compression parameters that characterize the chest compressions administered to the patient 100. For example, the CPR puck 104 includes an accelerometer, gyroscope, or other type of sensor configured to detect the frequency, timing, depth, or duty cycle of the chest compressions.

In some cases, the CPR puck 104 includes a compression sensor configured to detect the chest compressions. For example, the compression sensor is a capacitive sensor, a piezoresistive sensor, a piezoelectric sensor, a potentiometric sensor, or an optical pressure sensor. In various implementations, the CPR puck 104 includes multiple compression sensors positioned in different locations within the CPR puck 104. In some cases, the CPR puck 104 detects signals indicative of whether the hand 102 is administering chest compressions unevenly, such as based on a discrepancy between a compression detected by one compression sensor and a compression detected by another sensor.

In various implementations, the chest compression parameter(s) detected by the CPR puck 104 is utilized to provide feedback to the user about the quality of chest compressions being administered to the patient 100. In some cases, the feedback includes an instruction, such as an instruction to adjust the chest compression parameter(s) based on a comparison between the detected chest compression parameter(s) and one or more thresholds. According to some cases, the CPR puck 104 outputs a signal to the user that indicates the feedback. In some cases, the CPR puck 104 is communicatively coupled to an external device that outputs the feedback. For instance, the CPR puck 104 is paired or otherwise communicates with a monitor-defibrillator that outputs the feedback to the user.

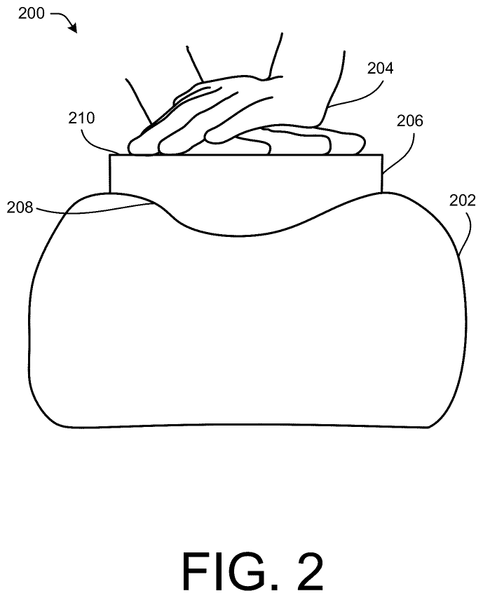

FIG. 2 illustrates a side view 200 of a user using a CPR puck 206 to resuscitate a patient 202, according to at least one example. The CPR puck 206 has a first surface 208 in contact with the patient 202. The CPR puck 206 may be adapted to conform with the shape of the patient 202, as shown. The CPR puck includes a securing device on a second surface 210 for securing the CPR puck 206 to the hand 204 of the user. The user may receive instructions based on an indicator included on the second surface 210 of the CPR puck 206 indicating a direction and/or orientation for use of the CPR puck 206. The user is shown placing both hands 204 on the CPR puck 206 to administer chest compressions. In some implementations, the CPR puck 206 may secure to one and/or both hands 204 of the user using one of the securing devices described herein.

In some implementations, the user receives instructions based at least in part on the CPR puck 206. For example, the CPR puck 206 may be used to provide feedback on compression force, frequency, depth, or other chest compression parameters using one or more sensors arrayed within the CPR puck 206 and/or associated therewith. The feedback and/or instructions may be provided through an interface device of the CPR puck 206 such as a display, speaker, or other such interface and/or through a device communicatively coupled with the CPR puck 206, such as a computing device, mobile phone, or other such device. In various implementations, the user may receive instructions from the indicators such as: hand placement, compression rate, compression depth, rate of mouth-to-mouth resuscitation, or any other instruction relevant to resuscitating a patient 202. According to the embodiment illustrated in FIG. 2, the user then proceeds to attempt resuscitating the patient 202. Attempting to resuscitate the patient 202 may include exerting force upon CPR puck 206 in order to compress the chest of the patient 202.

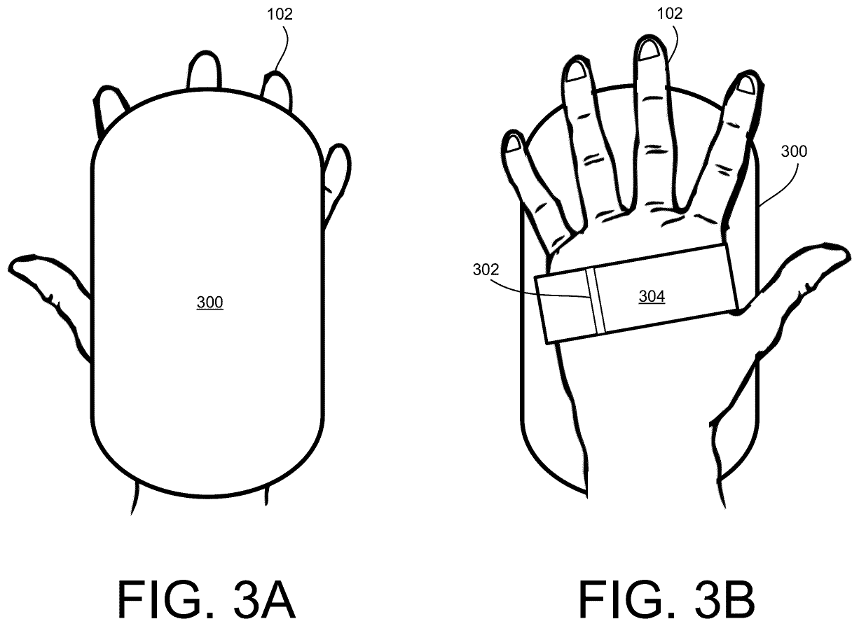

FIGS. 3A-3B illustrate a CPR puck 300 securable to a hand 102 of a user through an adjustable strap, according to at least one example. The strap 304 may be an example of a securing device that is used to secure, releasably, the CPR puck 300 to the hand 102. The CPR puck 300 has a strap 304 that couples to the hand 102 of the user to secure the CPR puck 300 in position while performing CPR. The strap 304 may be integrally formed with the CPR puck 300, may be riveted, adhered, stitched, or otherwise fastened to the CPR puck 300. The strap 304 may be formed of elastic materials that are cleanable, adjustable (as described below), and/or disposable. In some implementations, the strap 304 may include rubber and/or elastomeric fiber components that enable the strap to stretch and tighten around the hand 102.

In some implementations, the strap 304 may be formed of an inelastic material, such as a nylon, plastic, or other such materials.

In some implementations, the strap 304 includes an adjustment device to change the length of the strap 304 and thereby change the diameter of the opening defined by the strap 304 to accommodate different sizes of hands and to tighten around the hand 102 of the user.

The strap 304 enables the user to slide their hand 102 into the strap 304 so they are not required to grip and hold the CPR puck 300 while administering chest compressions. The strap 304 enables users who have hands that may be too small to effectively grasp the CPR puck 300 to keep the CPR puck 300 in place during chest compressions. This may also allow the user to relax their hand and straighten their fingers such that they can deliver chest compressions using the palm of their hand more effectively. Additionally, by securing the CPR puck 300 to the hand of the user with the strap 304, the hand 102 and CPR puck 300 can remain in contact and in correct position and orientation, even when slippery such as when the hand is sweaty, the CPR puck 300 gets fluid on it, or otherwise may be difficult to grasp.

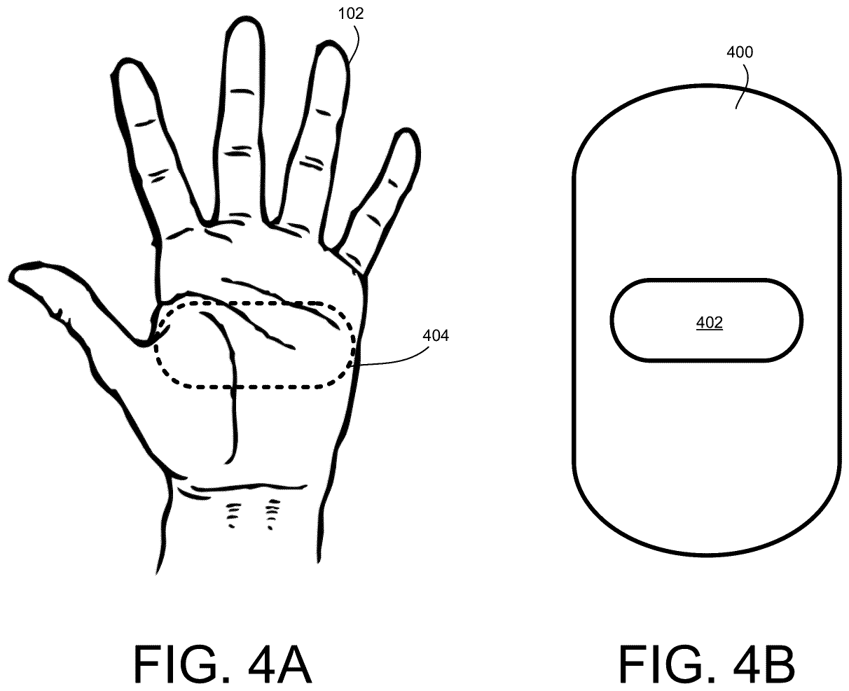

FIGS. 4A-4B illustrate a CPR puck 400 securable to a hand 102 of a user through an adhesive 402, according to at least one example. The adhesive 402 may secure to a portion 404 of the palm of the hand 102. The adhesive 402 may serve to keep the CPR puck 400 in position during chest compressions but also enable the user to easily remove the CPR puck 400 from their hand 102 when they are finished performing chest compressions.

The adhesive 402 may include a double-sided adhesive (e.g., double-sided tape) that sticks to the CPR puck 400, for example on the top side of the CPR puck 400 in the center of the face, and sticks to the portion 404 of the palm of the hand 102. The adhesive 402 may be covered by a material that prevents the adhesive 402 from becoming activated until the cover is removed and the user places their hand 102 in contact with the adhesive 402. In some implementations, the adhesive 402 may be pressure-activated. The adhesive 402 may be disposable and not be a permanent part of the CPR puck 400 and therefor the CPR puck 400 may be reusable by applying a new adhesive. The adhesive 402 may be selected based on bio-compatibility with skin of the hand 102 as well as a strength to retain the CPR puck 400 in position while also enabling the user to remove the CPR puck 400 when CPR is complete.

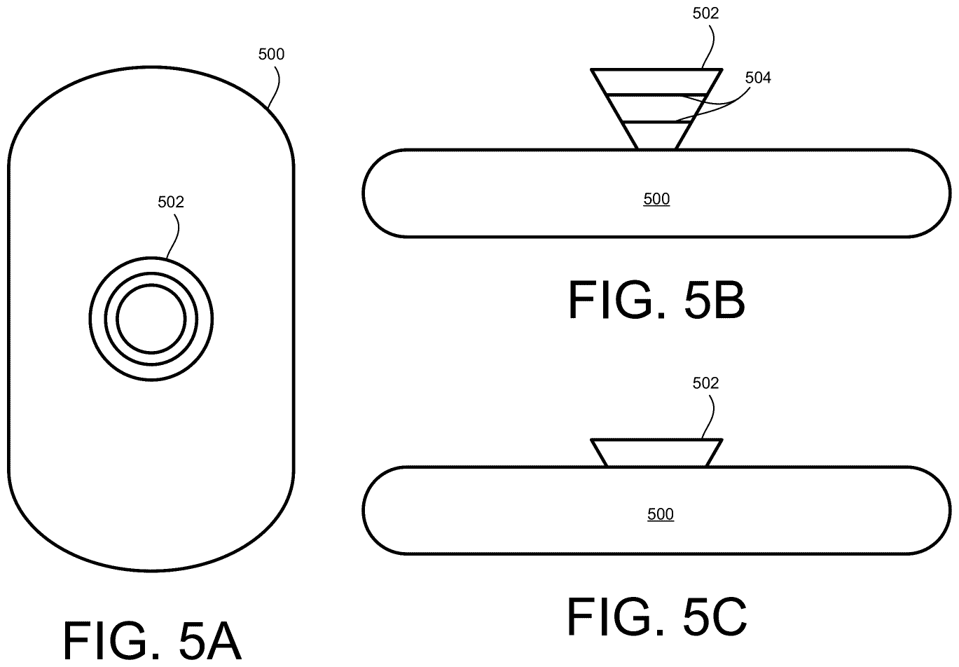

FIGS. 5A-5C illustrate a CPR puck 500 securable to a hand of a user through an accordion-style grip 502, according to at least one example. The CPR puck 500 may have a protrusion one a user engagement side of the CPR puck 500 to engage with the hand of the user. The protrusion may be configured to fit between fingers of the user to enable the user to maintain the position of the CPR puck 500 without requiring use of their fingertips to grasp the edges of the CPR puck 500. This may aid the user in maintaining a flat hand shape to improve their form to apply pressure primarily through the palm of the hand. The protrusion has a first cross-sectional area and/or diameter at a location proximate to the surface of the CPR puck 500 and a second cross-sectional area and/or diameter at a location distal from the surface of the CPR puck 500. The second cross-sectional area is greater than the first cross-sectional area such that the protrusion engages with the fingers and/or hand of the user to maintain contact with the CPR puck 500.

In some implementations, such as illustrated in FIGS. 5A-5C, the protrusion may include an accordion-style grip 502. The accordion style grip 502 uses a mechanism that is used on some mobile phone cases (e.g., a ‘Pop Socket’). The accordion-style grip may expand from the collapsed configuration shown in FIG. 5C into the expanded configuration shown in FIG. 5B. The accordion-style grip 502 may be made with a flexible material with concentrically placed cylinders that will allow the sections 504 to collapse or expand (e.g., similar to a collapsible drinking cup, a ‘Pop Socket’ used for holding cellular phones, etc.).

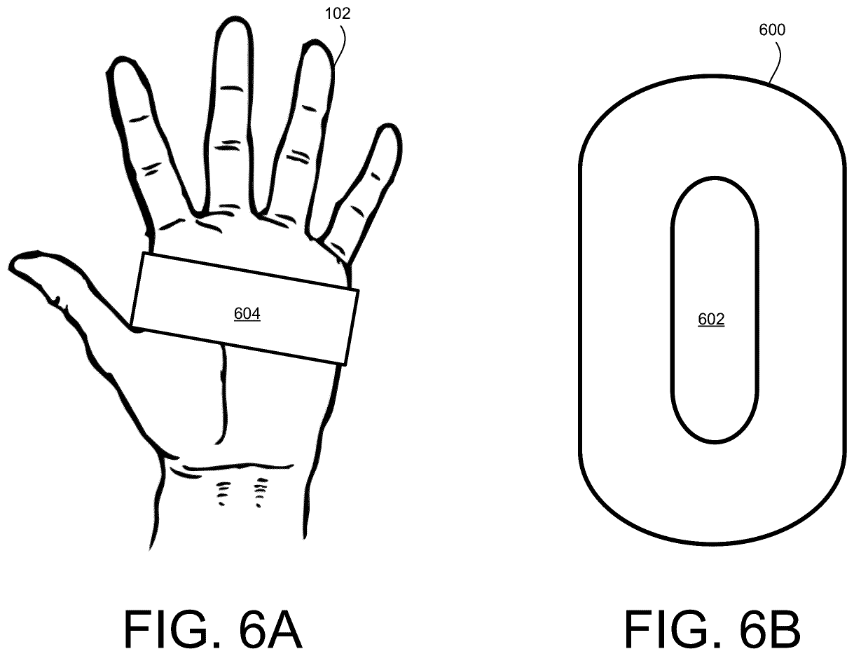

FIGS. 6A-6B illustrate a CPR puck 600 securable to a hand 102 of a user through a hook and loop fastener, according to at least one example. The user may slide a strap 604 onto their hand, the strap 604 may be similar to strap 304 of FIG. 3. The strap 604 may include a hook and loop fastener that is used to couple to a second hook and loop fastener 602 on the face of the CPR puck 600. In some implementations, the strap 604 may be an adjustable strap to provide a secure fit for various sizes and shapes of hands 102. The hook and loop fastener 602 may be more resistant to environmental changes, moisture, etc., as compared with other securing devices. Additionally, the user may be able to adjust the position of their hand 102 relative to the CPR puck 600 for comfort and/or effective use of the CPR puck 600.

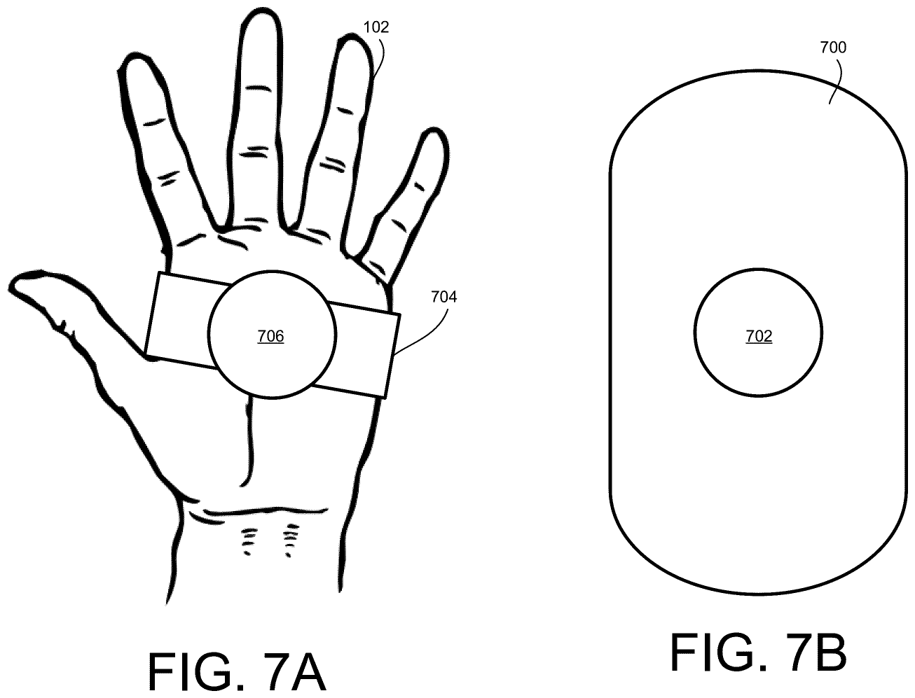

FIGS. 7A-7B illustrate a CPR puck 700 securable to a hand 102 of a user through a magnetic attachment, according to at least one example. The CPR puck 700 may include a first magnet 702 and/or ferromagnetic material at or near the surface of the CPR puck 700. The user may slide a strap 704, which may be similar to strap 304 and/or strap 604, onto their hand 102. The strap 704 includes a second magnet 706 and/or a ferromagnetic material. In some examples, the first magnet 702 may engage with the second magnet 706 to retain the CPR puck 700 with the hand 102. In some examples, the first magnet 702 and/or the second magnet may be replaced with a ferromagnetic material such that the first magnet 702 may engage with a ferromagnetic material coupled to the strap 704 and/or the second magnet 706 may engage with a ferromagnetic material coupled to the CPR puck 700. The polarity of the magnets may be opposite such that the magnetic elements are drawn towards each other.

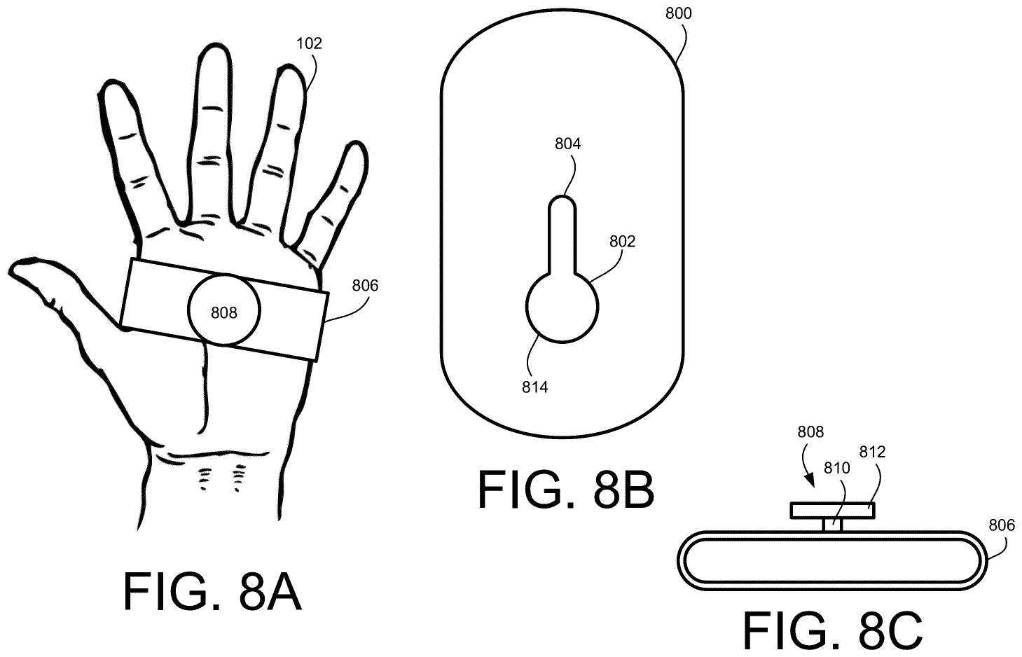

FIGS. 8A-8C illustrate a CPR puck 800 securable to a hand 102 of a user through a keyhole attachment, according to at least one example. The user may place a strap 806 on their hand 102. The strap 806 may be similar to strap 304, strap 604, and/or strap 704. The strap 806 includes a protrusion 808 coupled to the strap 806 that extends from the surface of the strap 806, as illustrated with respect to FIG. 8C. The protrusion 808 includes a first component 810 and a second component 812. The first component 810 has a first cross-sectional area and/or diameter while the second component 812 has a second cross-sectional area and/or diameter. The second cross-sectional area and/or diameter is greater than the first cross-sectional area such that the protrusion 808 may engage with a keyhole slot 802 of the CPR puck 800.

The keyhole slot 802 has an opening 814 that is sized to receive the protrusion 808 and a slot 804 that has a width dimension (perpendicular to the slot 804) smaller than a diameter of the second component 812. In this manner, the user may secure the strap 806 to their hand 102 and then may insert the protrusion 808 into the opening 814 and slide the protrusion 808 along slot 804. With the protrusion 808 in slot 804, the CPR puck 800 may be retained against the hand 102. The slot 804 may include one or more features such as detents to resist the protrusion 808 sliding from the slot 804 back to the opening 814. The user may apply additional force to overcome the detent to remove the protrusion 808 through opening 814. In some implementations, the keyhole slot 802 may be implemented on the strap 806 while the protrusion 808 is coupled to the CPR puck 800.

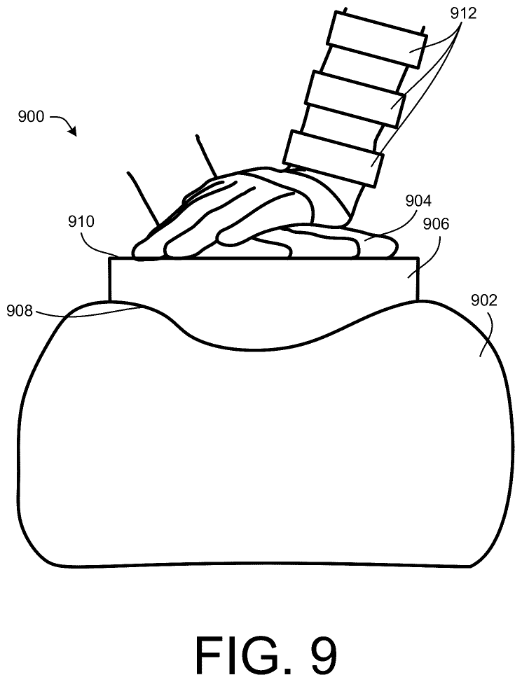

FIG. 9 illustrates an example 900 of a CPR puck 906 securable to a hand 904 of a user including a brace 912 for maintaining a wrist position of the user, according to at least one example. In some implementations, the CPR puck 906 contacts the patient 902 at surface 908 while on a surface 910, opposite the surface 908, the CPR puck 906 may secure to the hand 904 using one or more of the securing devices shown and described with respect to FIGS. 3-8. In some implementations, the securing device may also include a brace 912, similar to a wrist brace such that the user performing CPR has the correct wrist positioning and technique to avoid injury.

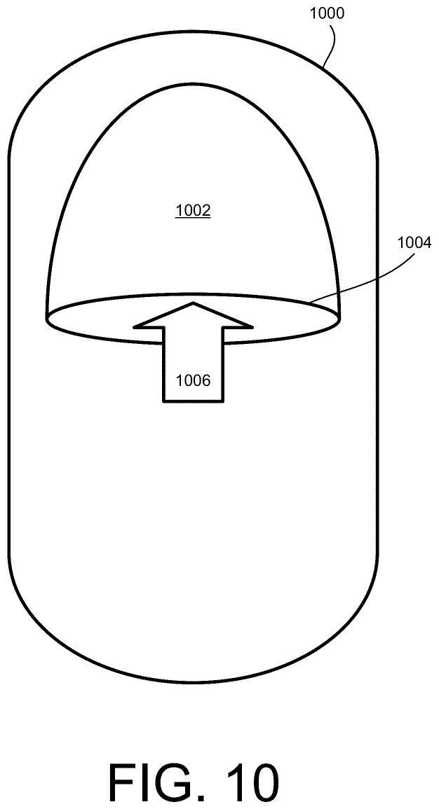

FIG. 10 illustrates a CPR puck 1000 having a sleeve 1002 for securing to a hand of a user, according to at least one example. The sleeve 1002 may be formed of an elastic material that stretches to accommodate the hand of the user through an opening 1004 and thereby retains the CPR puck 1000 in position relative to the hand of the user.

In some implementations, a sleeve having two compartments may be used, with the CPR puck 1000 inserted into a first compartment while the hand of the user would be inserted into the second compartment. The first compartment and the second compartment may be configured such that when in use as described, the hand of the user is positioned adjacent the surface of the CPR puck 1000. In such examples, the CPR puck 1000 may have different shapes and/or configurations that may be inserted into the sleeve based on patient parameters and also enables the use of CPR pucks from other sources without requiring the sleeve to be integrally formed or permanently affixed thereto. Sleeves of varying sizes may be available to accommodate different hand sizes.

### EXAMPLE CLAUSES

A. A resuscitation assistance device, comprising: a body configured to be disposed on a chest of a subject, the body having a first surface and a second surface, wherein the first surface is configured to contact the chest of the subject; a securing device coupleable to the second surface of the body, the securing device configured to releasably secure the body to a hand of a user; and a sensor configured to detect a compression of the body between the chest of the subject and the hand of the user.

B. The resuscitation assistance device of clause A, wherein the securing device comprises a strap configured to wrap around the hand of the user to releasably secure the body to the hand of the user.

C. The resuscitation assistance device of clause B, the hand being a first hand, wherein the strap comprises an adjustable portion configured to change a diameter of the strap to accommodate a size of the first hand and a size of the second hand, the size of the first hand being different than the size of the second hand.

D. The resuscitation assistance device of any of clauses B to C, wherein the strap comprises an elastic band.

E. The resuscitation assistance device of any of clauses A to D, wherein the securing device comprises an adhesive, the adhesive being protected by a cover configured to be removed to releasably secure the body to the hand of the user.

F. The resuscitation assistance device of clause E, wherein the adhesive comprises a double-sided adhesive tape.

G. The resuscitation assistance device of any of clauses A to F, wherein the securing device comprises an expandable protrusion, the expandable protrusion being adjustable to change a length of the expandable protrusion.

H. The resuscitation assistance device of clause G, wherein the expandable protrusion has a first cross-sectional area proximate to the second surface and a second cross-sectional area distal from the second surface.

I. The resuscitation assistance device of any of clauses A to H, wherein the securing device comprises a protrusion having a first cross-sectional area proximate to the second surface and a second cross-sectional area distal from the second surface.

J. The resuscitation assistance device of any of clauses A to I, wherein the securing device comprises: a strap configured to wrap around the hand of the user, the strap comprising a first portion of a hook and loop fastener; and a second portion of the hook and loop fastener coupled to the second surface of the body.

K. The resuscitation assistance device of clause J, wherein the strap is configured to tighten around the hand of the user using an adjustment component.

L. The resuscitation assistance device of any of clauses A to K, wherein the securing device comprises: a strap configured to wrap around the hand of the user, the strap comprising a first coupling component; and a second coupling component coupled to the second surface of the body.

M. The resuscitation assistance device of clause L, wherein the first coupling component comprises a first magnet.

N. The resuscitation assistance device of clause M, wherein the second coupling component comprises a second magnet.

O. The resuscitation assistance device of clause M or N, wherein the second coupling component comprises a ferromagnetic material.

P. The resuscitation assistance device of any of clauses L to O, wherein the first coupling component comprise a ferromagnetic material, and the second coupling component comprises a magnet.

Q. The resuscitation assistance device of any of clauses clause L to P, wherein the strap is configured to tighten around the hand of the user using an adjustment component.

R. The resuscitation assistance device of any of clauses L to Q, wherein: the first coupling component comprises a protrusion having a first cross-sectional area proximate to the strap and a second cross-sectional area distal from the strap, the second cross-sectional area greater than the first cross-sectional area; and the second coupling component comprises a keyhole slot configured to receive the protrusion.

S. The resuscitation assistance device of any of clauses L to R, wherein: the second coupling component comprises a protrusion having a first cross-sectional area proximate to the second surface and a second cross-sectional area distal from the second surface, the second cross-sectional area greater than the first cross-sectional area; and the first coupling component comprises a keyhole slot configured to receive the protrusion.

T. The resuscitation assistance device of any of clauses A to S, further comprising a brace configured to secure around a wrist of the user to position the hand and wrist of the user for performing CPR.

U. The resuscitation assistance device of clause T, wherein the brace is coupled to at least one of the body or the securing device.

V. The resuscitation assistance device of any of clauses A to U, wherein the securing device comprises a sleeve configured to receive the hand of the user.

W. A cardiopulmonary resuscitation (CPR) assistance device, comprising: a body configured to be disposed on a chest of a subject, the body having a first surface and a second surface, wherein the first surface is configured to contact the chest of the subject and the body is configured to transfer pressure from a user to the chest of the subject; a securing device coupleable to the second surface of the body, the securing device being configured to releasably secure the body to a hand of the user; and a sensor configured to detect the pressure from the user to the chest of the subject.

X. The CPR assistance device of clause W, wherein the securing device comprises a strap configured to wrap around the hand of the user to releasably secure the body to the hand of the user.

Y. A system, comprising: a cardiopulmonary resuscitation (CPR) device comprising a body configured to transmit compressions applied by the user to a chest of the subject; a securing device coupleable to the body, the securing device being configured to releasably secure the body to a hand of the user; and a sensor configured to detect the compressions applied by the user to the chest of the subject.

Z. A system, comprising: a resuscitation assistance device configured to removably attach to a hand of a rescuer, to detect compressions by the rescuer on a chest of a subject, and to transmit a communication signal indicating the compressions by the rescuer on the chest of the subject; and a monitor configured to receive the communication signal and to output a recommendation to the rescuer based on an analysis of the compressions by the rescuer on the chest of the subject.

AA. The system of clause Z, wherein the resuscitation assistance device comprises an elastic band, a strap, an adhesive, a glove, or a magnet configured to removably attach to the hand of the rescuer.

AB. The system of clause Z or AA, wherein the resuscitation assistance device comprises a compression sensor configured to detect the compressions by the rescuer on the chest of the subject.

AC. The system of any of clauses Z to AB, wherein the resuscitation assistance device comprises a transceiver configured to transmit the communication signal to the monitor.

AD. The system of any of clauses Z to AC, wherein the monitor comprises a monitor-defibrillator.

AE. The system of any of clauses Z to AD, wherein the monitor is configured to:

determine a chest compression parameter by analyzing the compressions by the rescuer on the chest of the subject; and determine that the chest compression parameter is above a first threshold or below a second threshold, wherein the recommendation comprises an instruction to adjust the chest compression parameter.

AF. The system of clause AE, wherein the chest compression parameter comprises a frequency of the compressions, a depth of the compressions, a duty cycle of the compressions, or a position of the compressions.

AG. The system of clause AE or AF, wherein the monitor is configured to generate the recommendation by analyzing an additional physiological parameter of the subject, the additional physiological parameter comprising an electrocardiogram (ECG), a transthoracic impedance, a blood oxygenation, a heart rate, a pulse rate, a velocity of blood in a blood vessel of the subject, or a blood pressure.

AH. A method comprising: applying a first surface of a cardiopulmonary resuscitation (CPR) device to a chest of a subject; securing a second surface of the CPR device to at least one of a hand or wrist of a provider by coupling a securing device of the CPR device to the hand or wrist of the provider; determining, using a sensor of the CPR device, compressions applied by the provider to the subject.

AI. The method of clause AH, wherein the securing device comprises an elastic band, a strap, an adhesive, a glove, or a magnet configured to removably attach to the hand of the rescuer.

While the example clauses described above are described with respect to one particular implementation, it should be understood that, in the context of this document, the content of the example clauses can also be implemented via a method, device, system, computer-readable medium, and/or another implementation. Additionally, any of examples A-AI may be implemented alone or in combination with any other one or more of the examples A-AI.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of, or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the implementation to the specified elements, steps, ingredients, or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is warranted, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value;

±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member is referred to and claimed individually or in any combination with other members of the group or other elements found herein. It is anticipated that one or more members of a group is included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

What is claimed is:

1. A resuscitation assistance device, comprising:
a body configured to be disposed on a chest of a subject, the body having a first surface and a second surface, wherein the first surface is configured to contact the chest of the subject;
a securing device coupleable to the second surface of the body, the securing device configured to releasably secure the body to a hand of a user; and
a sensor configured to detect a compression of the body between the chest of the subject and the hand of the user.

2. The resuscitation assistance device of claim 1, wherein the securing device comprises:
a strap configured to wrap around the hand of the user to releasably secure the body to the hand of the user;
an adhesive protected by a cover configured to be removed to releasably secure the body to the hand of the user;
an expandable protrusion adjustable to change a length of the expandable protrusion;
a protrusion having a first cross-sectional area proximate to the second surface and a second cross-sectional area distal from the second surface; or
a sleeve configured to receive the hand of the user.

3. The resuscitation assistance device of claim 2, the hand being a first hand, wherein the strap comprises an adjustable portion configured to change a diameter of the strap to accommodate a size of the first hand and a size of the second hand, the size of the first hand being different than the size of the second hand.

4. The resuscitation assistance device of claim 2, wherein the strap comprises an elastic band.

5. The resuscitation assistance device of claim 2, wherein the expandable protrusion has a first cross-sectional area proximate to the second surface and a second cross-sectional area distal from the second surface.

6. The resuscitation assistance device of claim 1, wherein the securing device comprises:
a strap configured to wrap around the hand of the user, the strap comprising a first portion of a hook and loop fastener; and
a second portion of the hook and loop fastener coupled to the second surface of the body, wherein the strap is configured to tighten around the hand of the user using an adjustment component.

7. The resuscitation assistance device of claim 1, wherein the securing device comprises:
a strap configured to wrap around the hand of the user, the strap comprising a first coupling component; and
a second coupling component coupled to the second surface of the body.

8. The resuscitation assistance device of claim 7, wherein the first coupling component comprises a first magnet or a ferromagnetic material, and
wherein the second coupling component comprises a second magnet or the ferromagnetic material.

9. The resuscitation assistance device of claim 7, wherein the strap is configured to tighten around the hand of the user using an adjustment component.

10. The resuscitation assistance device of claim 7, wherein:
the first coupling component comprises a protrusion having a first cross-sectional area proximate to the strap and a second cross-sectional area distal from the strap, the second cross-sectional area greater than the first cross-sectional area; and
the second coupling component comprises a keyhole slot configured to receive the protrusion.

11. The resuscitation assistance device of claim 7, wherein:
the second coupling component comprises a protrusion having a first cross-sectional area proximate to the second surface and a second cross-sectional area distal from the second surface, the second cross-sectional area greater than the first cross-sectional area; and
the first coupling component comprises a keyhole slot configured to receive the protrusion.

12. The resuscitation assistance device of claim 1, further comprising a brace configured to secure around a wrist of the user to position the hand and wrist of the user for performing CPR, wherein the brace is coupled to at least one of the body or the securing device.

13. A cardiopulmonary resuscitation (CPR) assistance device, comprising:
a body configured to be disposed on a chest of a subject, the body having a first surface and a second surface, wherein the first surface is configured to contact the chest of the subject and the body is configured to transfer pressure from a user to the chest of the subject;
a securing device coupleable to the second surface of the body, the securing device being configured to releasably secure the body to a hand of the user; and
a sensor configured to detect the pressure from the user to the chest of the subject.

14. The CPR assistance device of claim 13, wherein the securing device comprises a strap configured to wrap around the hand of the user to releasably secure the body to the hand of the user.

15. A system, comprising:
a resuscitation assistance device comprising:
an elastic band, a strap, an adhesive, a glove, or a magnet configured to removably attach to a hand of a rescuer,
a sensor configured to detect compressions by the rescuer on a chest of a subject, and
a transceiver configured to transmit a communication signal indicating the compressions by the rescuer on the chest of the subject; and
a monitor configured to receive the communication signal and to output a recommendation to the rescuer based on an analysis of the compressions by the rescuer on the chest of the subject.

16. The system of claim 15, wherein the resuscitation assistance device comprises an elastic band, a strap, an adhesive, a glove, or a magnet configured to removably attach to the hand of the rescuer.

17. The system of claim 15, wherein the monitor comprises a monitor-defibrillator.

18. The system of claim 15, wherein the monitor is configured to:
determine a chest compression parameter by analyzing the compressions by the rescuer on the chest of the subject; and
determine that the chest compression parameter is above a first threshold or below a second threshold,
wherein the recommendation comprises an instruction to adjust the chest compression parameter.

19. The system of claim 18, wherein the chest compression parameter comprises a frequency of the compressions, a depth of the compressions, a duty cycle of the compressions, or a position of the compressions.

20. The system of claim 18, wherein the monitor is configured to generate the recommendation by analyzing an additional physiological parameter of the subject, the additional physiological parameter comprising an electrocardiogram (ECG), a transthoracic impedance, a blood oxygenation, a heart rate, a pulse rate, a velocity of blood in a blood vessel of the subject, or a blood pressure.
